(19) United States
(12) Patent Application Publication
(10) Pub. No.: US 2022/0322634 A1
(43) Pub. Date: Oct. 13, 2022

(54) FEEDING DEVICE WITH STIRRING MECHANISM

(71) Applicant: KINPO ELECTRONICS, INC., NEW TAIPEI CITY (TW)

(72) Inventor: Wen-Kai TU, NEW TAIPEI CITY (TW)

(21) Appl. No.: 17/318,863

(22) Filed: May 12, 2021

(30) Foreign Application Priority Data
Apr. 8, 2021 (TW) 110112659

(51) Int. Cl. A01K 5/00; B01F 7/00; B01F 7/04; B65G 11/20

(52) U.S. Cl. CPC A01K 5/002; B01F 7/0025; B01F 7/00633; B01F 7/048; B65G 11/206; B01F 2215/0008

(57) ABSTRACT

A feeding device with a stirring mechanism includes a device body and a nautilus-shaped turning wheel. The device body includes a base and a storage barrel disposed above the base. A bottom of the storage barrel includes an opening. The nautilus-shaped turning wheel is pivoted on the base and accommodated in the opening. The axial direction of the opening is perpendicular to the axial direction of the nautilus-shaped turning wheel. An outer periphery of the nautilus-shaped turning wheel includes a spiral arc edge with a thickness gradually decreased along a rotating direction and a stepped wall formed between two ends of the spiral arc edge. Therefore, the feeding device has the function of stirring the feed and removing the jamming.

### BACKGROUND

Technical Field

The technical field relates to a feeding device for a feed, and particularly relates to a feeding device with a stirring mechanism.

Description of Related Art

Most pet owners pour the needed feed in the bowl for pets to eat while they are not at home. However, the above method has problems of irregular feeding time, unable to separate meals, and hygiene issue. In this condition, pets may overeat at the beginning and become hungry later, and that is harmful to the pets' health.

Therefore, an automatic feeder is provided in the related art. The automatic feeder includes a storage barrel and a gate valve switch installed at the opening of the storage barrel. The pet owner may pour the feed in the storage barrel first, and then the gate valve switch is turned on to expose the opening on the preset time. Thus, the feed may fall out from the opening of the storage barrel, and a meal of feed is provided.

However, when the opening of the storage barrel is blocked by the feed, the feed may not, or only a few feed, fall out from the opening of the storage barrel while the gate valve switch is turned on, and the automatic feeder may fail to discharge accurately. Therefore, how to design an automatic feeder of providing a pre-determined quantity of feed without jamming is the object of this disclosure.

In view of the above drawbacks, the inventor proposes this disclosure based on his expert knowledge and elaborate researches in order to solve the problems of related art.

### SUMMARY OF THE DISCLOSURE

The disclosure is directed to provide a feeding device with a stirring mechanism. When the nautilus-shaped turning wheel rotates along the rotating direction, the feed are moved upwardly and downwardly at the opening by the nautilus-shaped turning wheel. When the nautilus-shaped turning wheel rotates reversely along the rotating direction, the stepped wall may push the feed back to the storage barrel, so that the feeding device has the effect of stirring the feed and removing the jamming.

One of the exemplary embodiments, a feeding device with a stirring mechanism includes a device body having a base and a storage barrel disposed above the base, and a bottom of the storage barrel includes an opening. A nautilus-shaped turning wheel is pivoted on the base and accommodated in the opening, and an axial direction of the opening is perpendicular to an axial direction of the nautilus-shaped turning wheel, and an outer periphery of the nautilus-shaped turning wheel includes a spiral arc edge with a thickness gradually decreased along a rotating direction and a stepped wall formed between two ends of the spiral arc edge.

One of the exemplary embodiments, when the nautilus-shaped turning wheel rotates along the rotating direction, the thickness of the spiral arc edge is gradually decreased along the rotating direction, so that the spiral arc edge passes the opening first and pushes the feed upward gradually. Then, the stepped wall passes the opening to drive the feed to fall down, so that the feed are moved upwardly and downwardly at the opening by the nautilus-shaped turning wheel. Therefore, the feeding device has the function of stirring the feed to avoid the jamming.

One of the exemplary embodiments, when the nautilus-shaped turning wheel rotates reversely along the rotating direction, the stepped wall may push the feed back to the storage barrel when the feed blocks between the storage barrel and the nautilus-shaped turning wheel, so that the feeding device has the effect of removing the jamming by itself.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective explosion view of the feeding device of this disclosure.

FIG. 2 is a perspective assembly view of the feeding device of this disclosure.

FIG. 3 is another perspective assembly view of the feeding device of this disclosure.

FIG. 4 is a cross sectional view of the feeding device of this disclosure.

FIG. 5 is a first operation status view of the feeding device of this disclosure.

FIG. 6 is a second operation status view of the feeding device of this disclosure.

FIG. 7 is a third operation status view of the feeding device of this disclosure.

FIG. 8 is a fourth operation status view of the feeding device of this disclosure.

FIG. 9 is a fifth operation status view of the feeding device of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

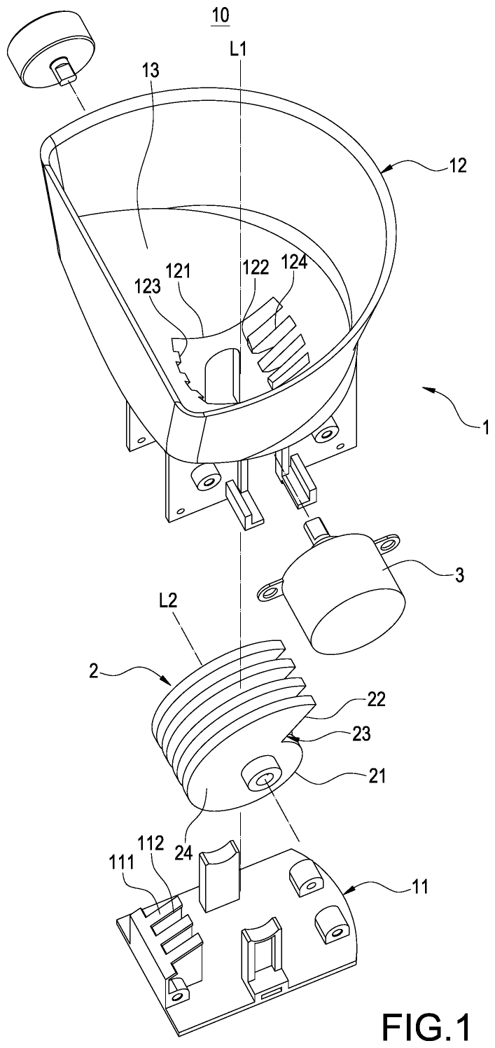

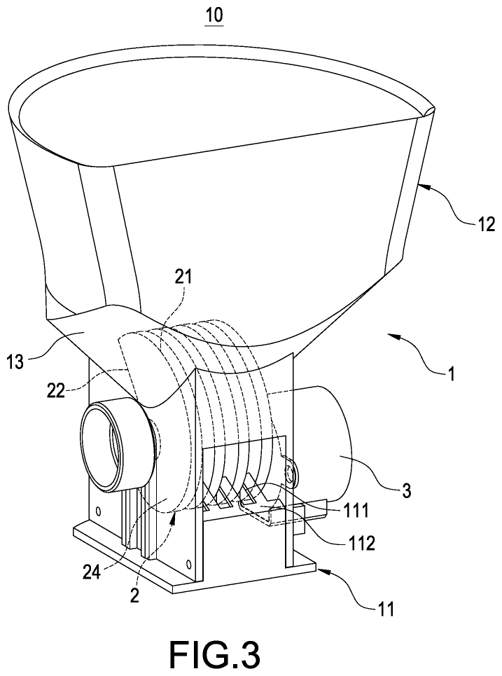

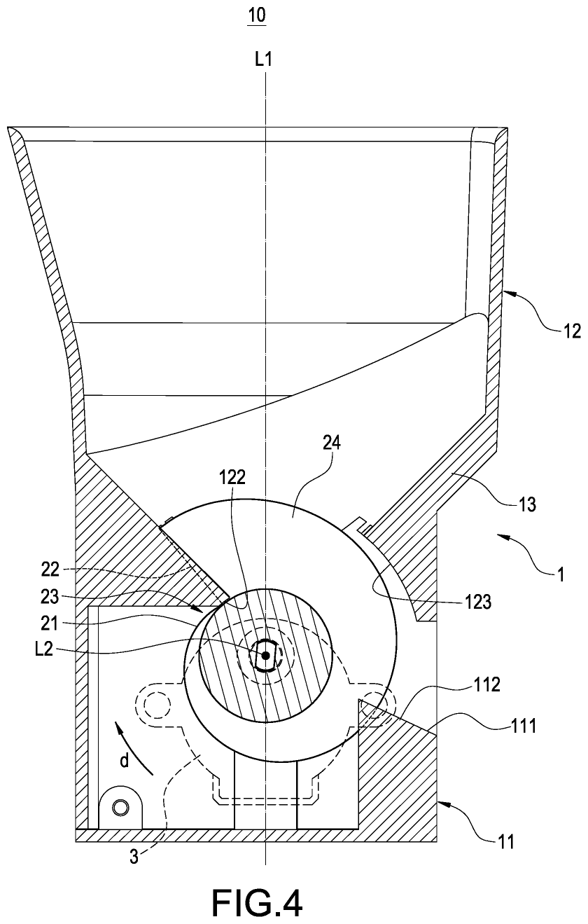

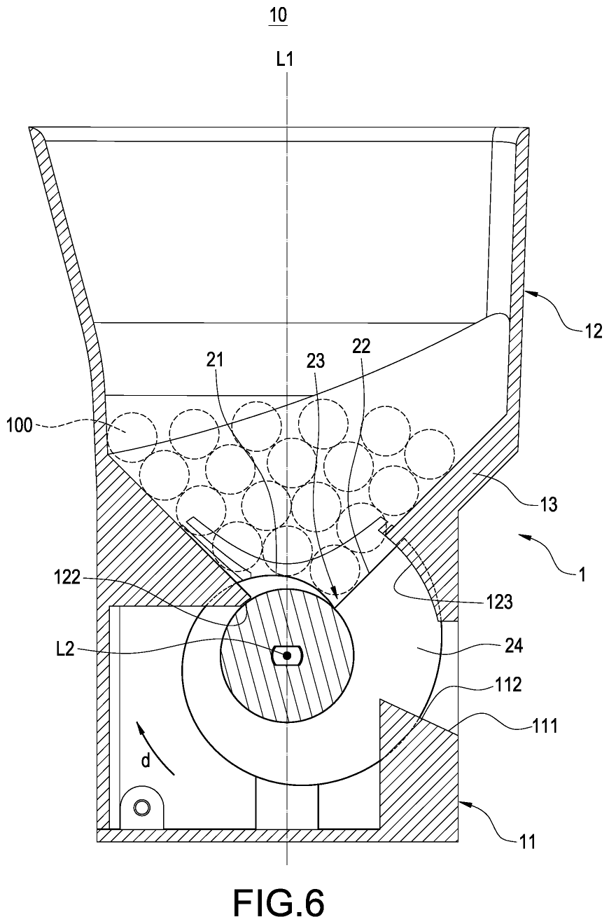

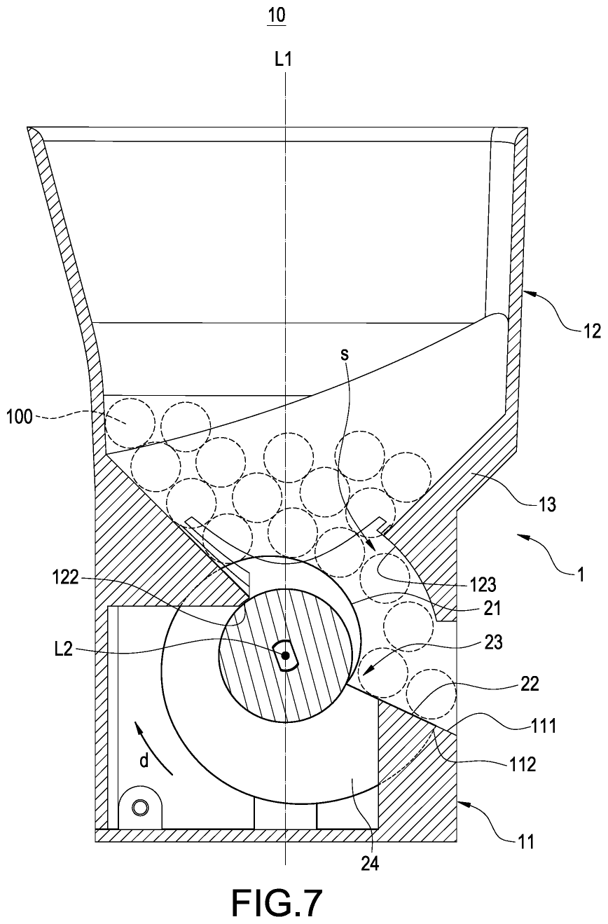

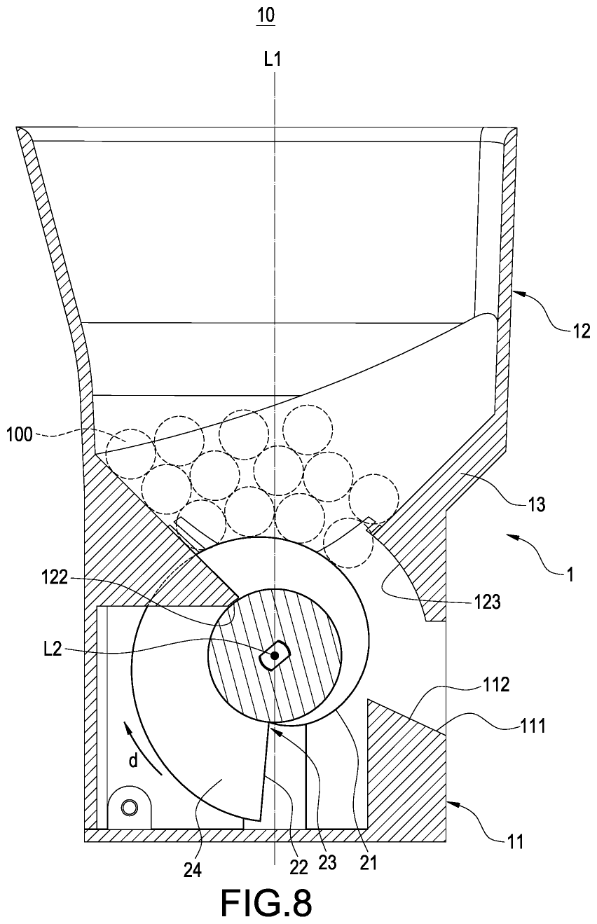

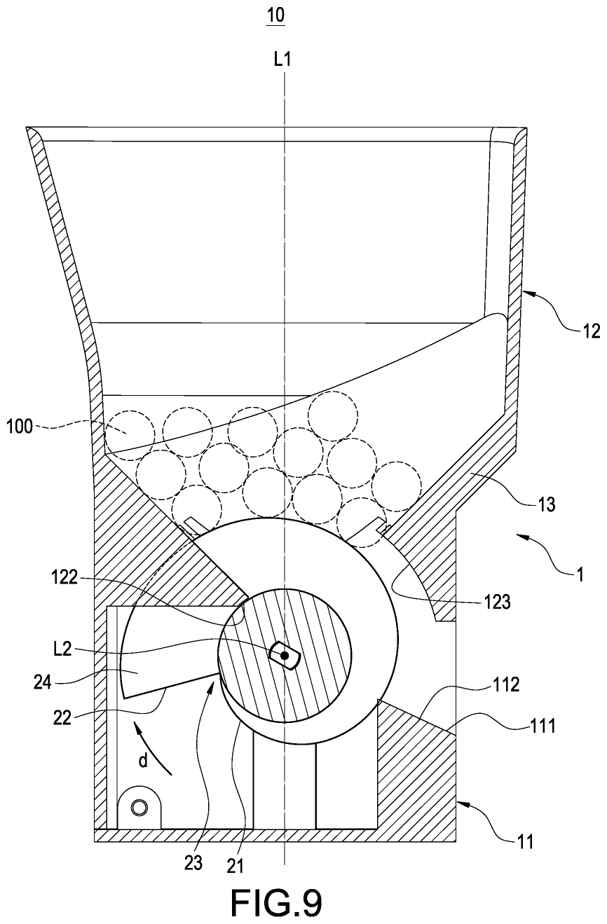

Please refer to FIG. 1 to FIG. 9. This disclosure provides a feeding device with a stirring mechanism. The feeding device 10 mainly includes a device body 1 and a nautilus-shaped turning wheel 2.

As shown in FIG. 1 to FIG. 9, the device body 1 includes a base 11 and a storage barrel 12 disposed above the base 11. The storage barrel 12 is used to store feed (pellets) 100, and the bottom of the storage barrel 12 is provided with an opening 121. In this embodiment, the storage barrel 12 is a funnel-shaped cup 13.

More detailed is as follows. An inner edge of the opening 121 includes a first inner side wall 122 and a second inner side wall 123 located oppositely. The base 11 includes a guiding slope 111 arranged below the second inner side wall 123, and the guiding slope 111 is provided with a plurality of first claw grooves 112. The storage barrel 12 is provided with a plurality of second claw grooves 124 penetrating through the first inner side wall 122.

As shown in FIG. 1 to FIG. 9, the nautilus-shaped turning wheel 2 is pivoted on the base 11 and accommodated in the opening 121. The axial direction L1 of the opening 121 is perpendicular to the axial direction L2 of the nautilus-shaped turning wheel 2. An outer periphery of the nautilus-shaped turning wheel 2 includes a spiral arc edge 21 with a thickness gradually decreased along the rotating direction d and a stepped wall 22 formed between two ends of the spiral arc edge 21. Additionally, a V-shaped groove 23 is configured collectively by the spiral arc edge 21 and the stepped wall 22.

Further explanation is as follows. The nautilus-shaped turning wheel 2 includes a plurality of nautilus-shaped tabs 24 arranged spacedly and overlapped with each other. The shapes of the nautilus-shaped tabs 24 are the same with each other. The spiral arc edge 21 and the stepped wall 22 are formed on outer peripheries of the plural nautilus-shaped tabs 24, and the nautilus-shaped tabs 24 are capable of passing through the first claw grooves 112 and the second claw grooves 124. The diameter of the feed 100 is greater than that of the first claw grooves 112 and that of the second claw grooves 124, so that the feed 100 may not pass through the first claw grooves 112 and the second claw grooves 124.

When the nautilus-shaped turning wheel 2 rotates along the rotating direction d, the stepped wall 22 may pass the first inner side wall 122, the second inner side wall 123 and the guiding slope 111 in sequence.

Additionally, when the stepped wall 22 is located between the second inner side wall 123 and the guiding slope 111 or the stepped wall 22 and the guiding slope 111 are located on a same level, the distance between the spiral arc edge 21 and the second inner side wall 123 is greater than a pre-determined distance to form a discharge port s. The pre-determined distance is the diameter of the feed 100, so that the feed 100 in the storage barrel 12 may fall down from the discharge port s.

Moreover, when the stepped wall 22 is located between the first inner side wall 122 and the second inner side wall 123 or the stepped wall 22 is located between the first inner side wall 122 and the guiding slope 111, the distance between the spiral arc edge 21 and the second inner side wall 123 is less than the pre-determined distance, i.e., the distance between the spiral arc edge 21 and the second inner side wall 123 is less than the diameter of the feed 100, to prevent the feed 100 from falling out of the storage barrel 12.

As shown in FIG. 1 to FIG. 4, the feeding device 10 of this disclosure further includes a motor 3. The motor 3 is installed on the base 11, and the nautilus-shaped turning wheel 2 is driven by the motor 3 to rotate along the rotating direction d or rotate reversely along the rotating direction d.

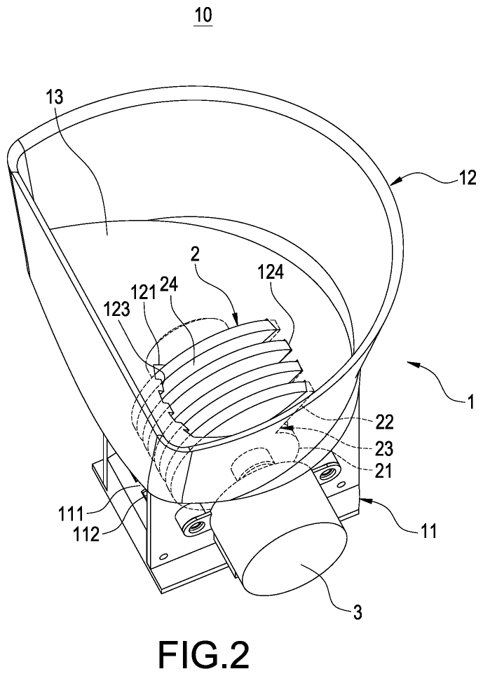

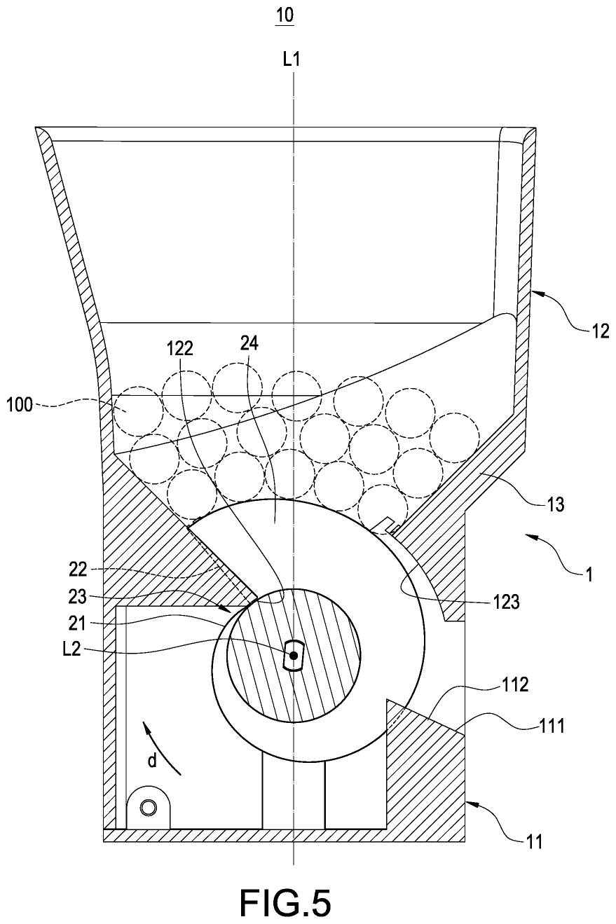

As shown in FIG. 2, and FIG. 5 to FIG. 9, the feeding device 10 of this disclosure are in operation. When the nautilus-shaped turning wheel 2 is driven by the motor 3 to rotate along the rotating direction d, the thickness of the spiral arc edge 21 is gradually decreased along the rotating direction d, so that the spiral arc edge 21 passes the opening 121 first and pushes the feed 100 upward gradually. Then, the stepped wall 22 passes the opening 121 and drives the feed 100 to fall to the V-shaped groove 23, so that the feed 100 are moved upwardly and downwardly at the opening 121 by the nautilus-shaped turning wheel 2. Therefore, the feeding device 10 has the function of stirring the feed 100 to avoid the jamming.

After that, when the stepped wall 22 is located between the second inner side wall 123 and the guiding slope 111 or the stepped wall 22 and the guiding slope 111 are located on the same level, the distance between the spiral arc edge 21 and the second inner side wall 123 is greater than the diameter of the feed 100 to form the discharge port s. Thus, the feed 100 in the V-shaped groove 23 may fall out from the discharge port s at a time. The feed 100 are guided by the stepped wall 22 to fall on the guiding slope 111. The guiding slope 111 may guide the feed 100 to fall out from the base 11, so that the feeding device 10 has the characteristics of discharging smoothly and quantitative feeding.

Furthermore, in the process of the nautilus-shaped turning wheel 2 driving the feed 100 to fall out from the discharge port s, the distance between the spiral arc edge 21 and the second inner side wall 123 is gradually decreased, and that may cause the feed 100 to block between the second inner side wall 123 and the nautilus-shaped turning wheel 2. However, when the jamming occurs in the feeding device 10, the nautilus-shaped turning wheel 2 may be driven by the motor 3 to rotate reversely along the rotating direction d to drive the stepped wall 22 to move from the second inner side wall 123 to the first inner side wall 122. At the same time, the stepped wall 22 may push the feed pellets 100 blocking between the second inner side wall 123 and the nautilus-shaped turning wheel 2 to the storage barrel 12, so that the feeding device 10 has the advantage of being able to remove the jamming by itself.

While this disclosure has been described by means of specific embodiments, numerous modifications and variations could be made thereto by those skilled in the art without departing from the scope and spirit of this disclosure set forth in the claims.

What is claimed is:

1. A feeding device with a stirring mechanism, the feeding device comprising:
a device body, comprising a base and a storage barrel disposed above the base, and an opening disposed on a bottom of the storage barrel; and
a nautilus-shaped turning wheel, pivoted on the base and accommodated in the opening, and an axial direction of the opening being perpendicular to an axial direction of the nautilus-shaped turning wheel, and an outer periphery of the nautilus-shaped turning wheel comprising a spiral arc edge with a thickness gradually decreased along a rotating direction and a stepped wall disposed between two ends of the spiral arc edge.

2. The feeding device with the stirring mechanism according to claim 1, wherein a V-shaped groove is configured by the spiral arc edge and the stepped wall.

3. The feeding device with the stirring mechanism according to claim 1, wherein the nautilus-shaped turning wheel comprises a plurality of nautilus-shaped tabs arranged spacedly and overlapped with each other, and the spiral arc edge and the stepped wall are disposed on an outer periphery of the nautilus-shaped tabs.

4. The feeding device with the stirring mechanism according to claim 3, wherein an inner edge of the opening comprises a first inner side wall and a second inner side wall located oppositely, and the storage barrel comprises a plurality of second claw grooves penetrating through the first inner side wall, and the nautilus-shaped tabs pass through the second claw grooves.

5. The feeding device with the stirring mechanism according to claim 4, wherein the base comprises a guiding slope arranged below the second inner side wall, and the guiding slope comprises a plurality of first claw grooves, and the nautilus-shaped tabs pass through the first claw grooves.

6. The feeding device with the stirring mechanism according to claim 5, wherein when the stepped wall is located between the second inner side wall and the guiding slope, a discharge port is configured in a manner of a distance between the spiral arc edge and the second inner side wall being greater than a pre-determined distance.

7. The feeding device with the stirring mechanism according to claim 6, wherein when the stepped wall and the guiding slope are located on a same level, the discharge port is configured in the manner of the distance between the spiral arc edge and the second inner side wall is greater than the pre-determined distance.

8. The feeding device with the stirring mechanism according to claim 7, wherein when the stepped wall is located between the first inner side wall and the second inner side wall or the stepped wall is located between the first inner side wall and the guiding slope, the distance between the spiral arc edge and the second inner side wall is less than the pre-determined distance.

9. The feeding device with the stirring mechanism according to claim 1, wherein the storage barrel comprises a funnel-shaped cup.

10. The feeding device with the stirring mechanism according to claim 1, further comprising: a motor, installed on the base, and the nautilus-shaped turning wheel being driven by the motor to rotate along the rotating direction or rotate reversely along rotating direction.
